(19) United States
(12) Patent Application Publication
(10) Pub. No.: US 2004/0193649 A1
(43) Pub. Date: Sep. 30, 2004

(54) Method and apparatus for searching recommended music in the internet, and a computer-readable medium encoded with a plurality of processor-executable instruction sequences for searching recommended music in the internet

(76) Inventors: Kiyoaki Doshida, Yokohama (JP); Yuichi Hirose, Tokyo (JP); Tomomi Kasahara, Tokyo (JP)

Correspondence Address: SWIDLER BERLIN SHEREFF FRIEDMAN, LLP, 3000 K STREET, NW, BOX IP, WASHINGTON, DC, 20007, US

(21) Appl. No.: 10/779,673

(22) Filed: Feb. 18, 2004

(30) Foreign Application Priority Data
Mar. 24, 2003 (JP) 2003-080619

(51) Int. Cl. G06F 7/00

(52) U.S. Cl. 707/104.1

(57) ABSTRACT

An apparatus for searching for recommended music in the internet for a listener includes a genre list database, a selection history database, an artist's genre database, and an extracting section for extracting the corresponding genre names to the given music titles or artist names in the selection history database, by using the artist's genre database. This extraction is initiated by receiving a request for internet-search. The apparatus further includes a search request section for sending a search request to the predefined WWW server to download the music, with searching keyword of the genre names which are included in the genre list database, but which are not included in the extracted genre names by the extracting section. The apparatus further includes a result display unit for receiving a search result from the WWW server and displaying the search result on the apparatus.

### BACKGROUND OF THE INVENTION

1. Field of the Invention

The present invention relates to a recommended music search apparatus for obtaining, based on the genre of music broadcast on a radio station selected by a user (i.e. selected-genre) and information of a given music genre list including various music genres, such music and/or associated information as recommended music, of which genre is not same to said selected-genre but is included in said genre list.

2. Description of the Related Art

Japanese Unexamined Patent Application Publication No. 2001-343979 discloses a music/information program providing apparatus for use in a vehicle and for providing a music/information program that suits user's taste based on a pre-registered user profile.

With this known technology, it is still impossible to provide a new music/information program considering a history of user's operation of the music/information providing apparatus. For example, when the user is searching for a radio station broadcasting music that suits his/her mood, the apparatus cannot obtain such music that suits his/her mood and information associated with the music, by considering the genre of music broadcast on a radio station previously selected by the user.

### SUMMARY OF THE INVENTION

One of the objects of the present invention is to provide a method and an apparatus for providing a user with music that suits his/her mood and information associated with the music by automatically searching the internet.

More specifically, the present invention provides an apparatus for searching for recommended music in the internet for a listener. The apparatus includes a genre list database for storing information of a given music genre list, a selection history database for storing the frequency of a selected radio station, broadcast music titles and artist names, and an artist's genre database for storing given music titles and corresponding artist names and its genre names. The apparatus further includes an extracting section for extracting the corresponding genre names to the given music titles or artist names in the selection history database, by using the artist's genre database. The extraction is initiated by receiving a request for internet-search. The apparatus further includes a search request section for sending a search request to the predefined WWW server to download the music, with searching keyword of the genre names which are included in the genre list database, but which are not included in the extracted genre names by the extracting section, and a result display section for receiving a search result from the WWW server, and displaying it on the apparatus.

### BRIEF DESCRIPTION OF THE DRAWINGS

FIG. 1 is a block diagram illustrating the configuration of a system according to an embodiment of the present invention;

FIG. 2 is a flow chart illustrating a search condition setting means in the embodiment of the present invention;

FIG. 3 is a flow chart illustrating a selection history storing means in the embodiment of the present invention;

FIG. 4 is a flow chart illustrating a recommended music search means in the embodiment of the present invention;

FIG. 5 shows a genre list database in the embodiment of the present invention;

FIG. 6 is a selection history database in the embodiment of the present invention;

FIG. 7 is an artist's genre database in the embodiment of the present invention; and

FIG. 8 shows examples of an operation screen in the embodiment of the present invention.

### DESCRIPTION OF THE PREFERRED EMBODIMENT

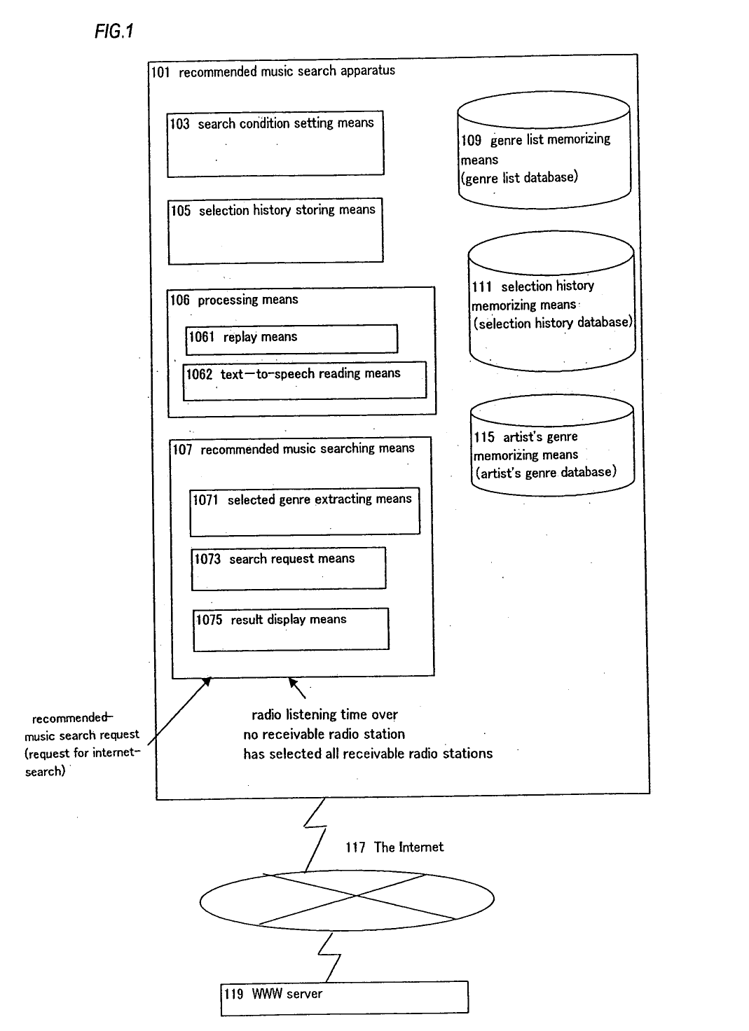

A recommended music search apparatus according to an embodiment of the present invention will be described below in detail with reference to the accompanying drawings. FIG. 1 is a schematic diagram of functional modules of the apparatus according to the present invention in relation to its network connection. In the figure, a recommended music search apparatus 101 is a computer, which includes a processor and a memory, and searches for recommended music in the internet for a listener. The recommended music search apparatus 101 is connected over a network 117 to a WWW server 119, which stores music and information associated with the music. A program for causing the computer to serve as the recommended music search apparatus 101 is stored in a computer-readable medium and is supplied.

In the drawing, reference numeral 109 depicts a genre list memorizing means for storing information of a given music genre list, so, it is also called a genre list database (DB). Reference numeral 115 depicts an artist's genre memorizing means for storing given music titles and corresponding artist names and its genre names, so, it is also called as an artist's genre database.

Reference numeral 103 depicts a search condition setting means for setting initial-entry request information regarding recommended-music's search-condition, received from a user, in the genre list database 109 and/or the artist's genre database 115. Reference numeral 111 depicts a selection history memorizing means for storing the frequency of a selected radio station, broadcast music titles and artist names, so, it is also called as a selection history database. Reference numeral 105 depicts a selection history storing means for storing a radio-station selection history, received from the user, in the selection history database 111.

Reference numeral 107 depicts a recommended music search means for searching and getting recommended music from the internet, the recommended music decided from the information stored in the selection history database 111. Reference numeral 1071 depicts a selected-genre extracting means for extracting the corresponding genre names to given selected music titles or artist names, by using an artist's genre database 115. Reference numeral 1073 depicts a search request means 1073 for sending a search request to the predefined WWW server to download the music, with searching keywords. Reference numeral 1075 depicts a result display means for receiving a search result from the WWW server 119, and displaying it on the apparatus 101.

Reference numeral 106 depicts a processing means for processing a search result from a WWW server, by using the predefined processes, for example, a replay means 1061 for replaying a sound-source file or a text-to-speech means 1062 for text-to-speech reading.

Each functional module or means referred to above is embodied by way of instruction sequences of a software program which is to be stored in a computer-readable medium and executed by a general purpose computer. The software program will be described in detail here under in reference to the drawings depicting its flowcharts.

First, a process for setting a search condition for setting initial-entry request information regarding recommended-music's search-condition, received from a user, in the genre list database 109 and/or the artist's genre database 115 will be described with reference to FIGS. 1, 2, 5, 7, and 8.

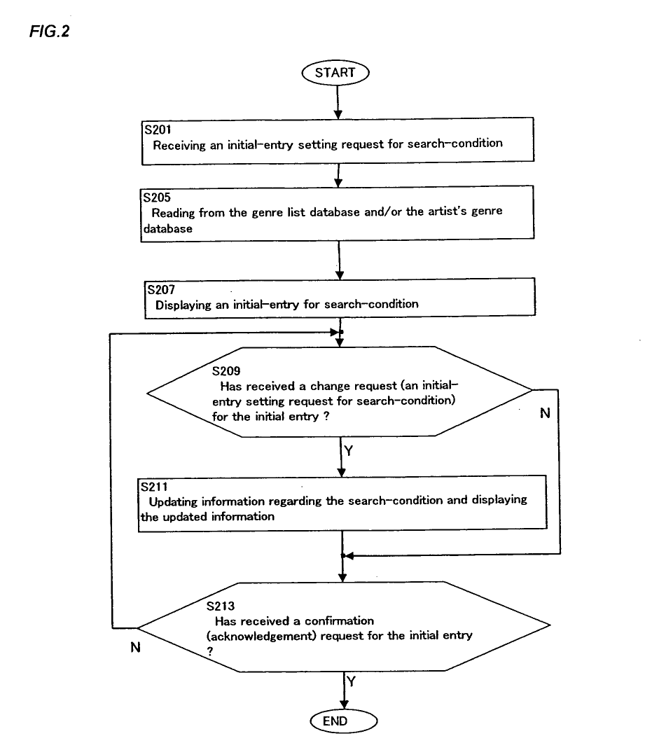

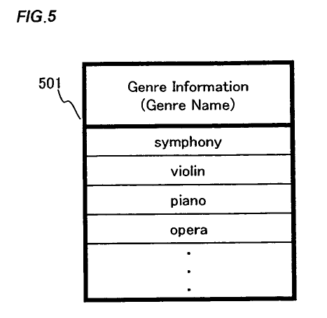

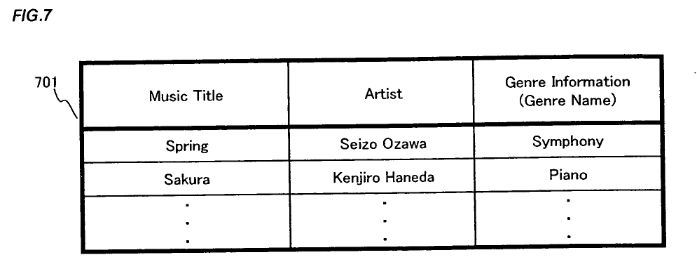

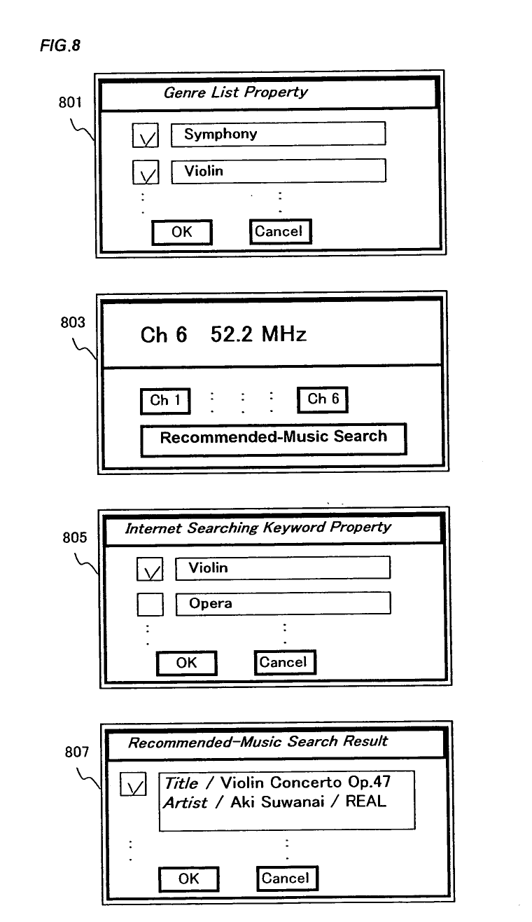

FIG. 2 is a flow chart illustrating the operation of the search condition setting means 103. FIG. 5 shows specific content of the genre list database 109. FIG. 7 shows specific content of the artist's genre database 115. FIG. 8 shows examples of an operation screen which is not shown but which is provided at the recommended music search apparatus 101 so as to be operated by the user.

With reference to FIG. 2, a description is now given of the operation of the search condition setting means 103 for setting initial-entry request information regarding recommended-music's search-condition, received from a user, in the genre list database 109 and/or the artist's genre database 115.

In step S201, the search condition setting means 103 receives an initial-entry setting request for search-condition from the user. In step S205, the search condition setting means 103 performs reading from the genre list database 109 and/or the artist's genre database 115, both of which are set before product shipment. Next, in step S207, the search condition setting means 103 displays an initial-entry for search-condition including information in the genre list database 109 and the artist's genre database 115. In step S209, a determination is made as to whether the search condition setting means 103 has received a change request (an initial-entry setting request for search-condition) for the initial entry.

As a result of the determination, when the search condition setting means 103 has received the change request (the initial-entry setting request for search-condition). In step S211, the search condition setting means 103 updates information, which corresponds to the change request, in the genre list database 109 and/or the artist's genre database 115, and also displays the updated information on the operation screen. As a result of the determination, when the search condition setting means 103 has not received a change request for the initial entry, in step S213, a determination is made as to whether the search condition setting means 103 has received a confirmation (acknowledgement) request for the initial entry.

As a result of the determination, when the search condition setting means 103 has received a confirmation request for the initial entry, it does nothing and ends the processing. As a result of the determination, when the search condition setting means 103 has not received a confirmation request for the initial entry, the process returns to S209, in which a determination is made again as to whether the search condition setting means 103 has received a change request (the initial-entry setting request for search-condition) for the initial value.

Reference numeral 501 in FIG. 5 indicates content of the genre list database 109 after an initial-entry for search-condition is set. It is shown that “symphony”, “violin”, “piano”, and “opera” are stored as genre information. In addition to these genres, the user can store genre information, such as “jazz”, “rock”, and “pops”, as needed.

Reference numeral 701 in FIG. 7 indicates content of the artist's genre database 115 after a search condition is set. It is shown that, as artist's genre-associated information, “Music title: Spring/Artist: Seizo Ozawa/Genre name: Symphony” and “Music title: Sakura/Artist: Kenjiro Haneda/Genre name: Piano” are stored as artist-genre information.

Reference numeral 801 in FIG. 8 is an example of the operation screen displayed when a search condition for a genre list is set. When check boxes corresponding to genres “symphony” and “violin”, which are set as initial entries, are checked, this indicates that “symphony” and “violin” are available for a recommended music search process. Search conditions for artist genres, which are not shown, can also be set by a similar operation.

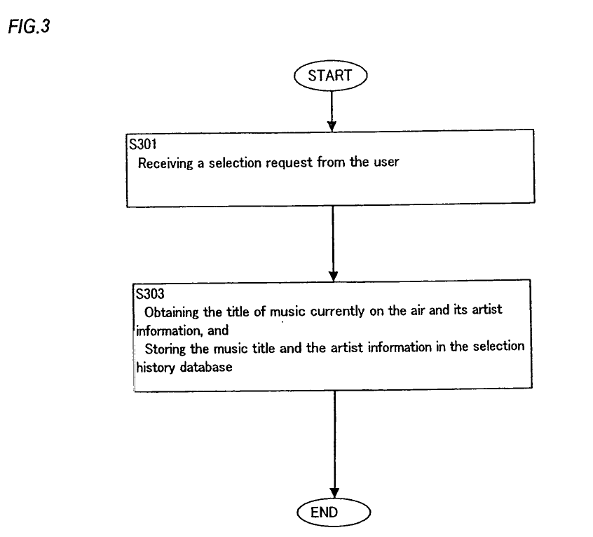

The operation of the selection history storing means 105 for storing the radio-station selection history, received from the user, in the selection history database 111 will now be described with reference to FIG. 3.

In step S301, the selection history storing means 105 receives a selection request from the user. In step S303, the selection history storing means 105 connects to a radio station's WWW server based on the frequency of a selected radio station, obtains the title of music currently on the air and its artist information, and stores the music title and the artist information in the selection history database 111. The music title and the artist information are stored therein until the selection history storing means 105 receives another selection request from the user or recommended-music search request (request for internet-search).

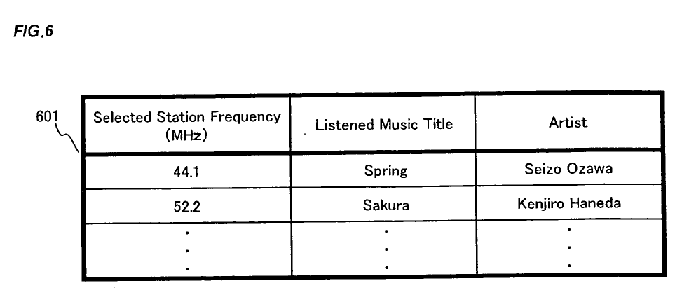

Reference numeral 601 in FIG. 6 indicates content of the selection history database 111 after the selection history storing means 105 receives another selection request from the user or recommended-music search request (request for internet-search). It is shown that “Frequency: 44.1/Music title: Spring/Artist: Seizo Ozawa” and “Frequency: 52.2/Music title: Sakura/Artist: Kenjiro Haneda” are stored as selection histories.

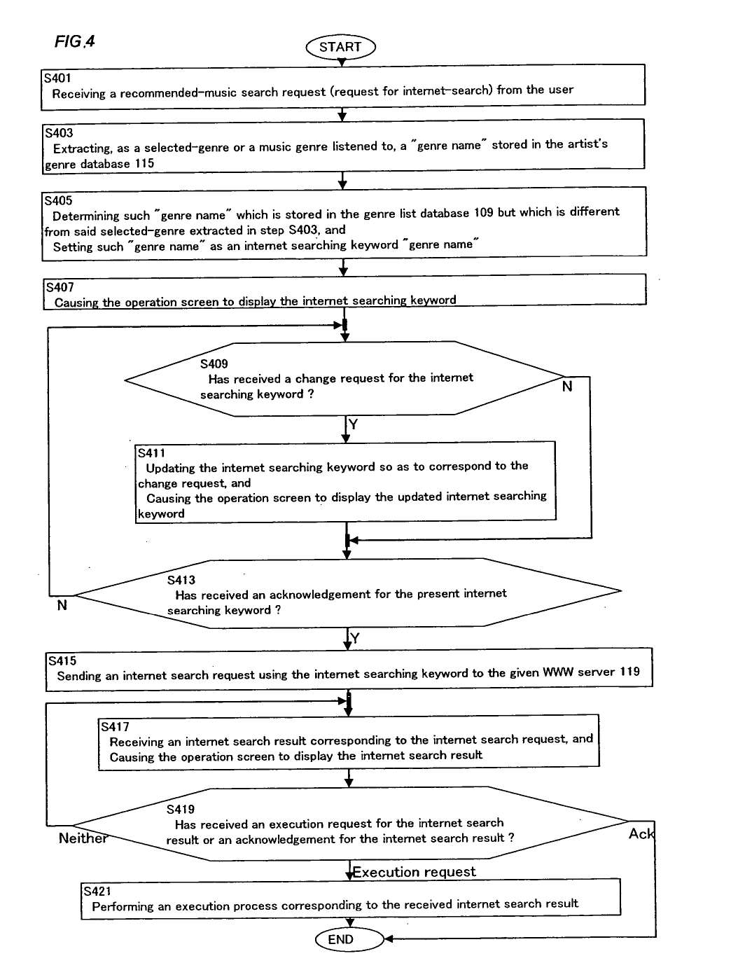

With reference to FIG. 4, a description is now given of the operation of the recommended music search means 107. In this case, when the user gives a recommended-music search request (request for internet-search), the recommended music search means 107 uses music genres determined based on the selection history database 111 and the artist's genre database 115, determines the selected-genre and determines an internet searching keyword based both on the selected-genre and on the genre list of the genre list database 109 in order to obtain such music and information associated with the music of which genre is not same to said selected-genre but is included in said genre list.

Reference numeral 803 in FIG. 8 is an example of the operation screen displayed when the user presses a recommended-music search button of the recommended music search apparatus 101 to give a recommended-music search request (request for internet-search) to the apparatus 101.

In step S401, the recommended music search means 107 receives a recommended-music search request (request for internet-search) from the user. In step S403, the recommended music search means 107 causes the selected-genre extracting means 1071 to perform reading from the selection history database 111 and the artist's genre database 115. That is, using search keys “music title” and “artist” stored in the selection history database 111, the selected-genre extracting means 1071 extracts, as a selected-genre or a music genre listened to, a “genre name” stored in the artist's genre database 115.

In step S405, using the genre list memorizing means(genre list database) 109, the search request means 1073 determines such “genre name” which is stored in the genre list database 109 but which is different from said selected-genre extracted in step S403, and set such “genre name” as an internet searching keyword “genre name”.

In step S407, the recommended music search means 107 causes the operation screen to display the internet searching keyword.

In step S409, a determination is made as to whether the recommended music search means 107 has received a change request for the internet searching keyword.

As a result of the determination, when the recommended music search means 107 has received a change request for the internet searching keyword, in step S411, the recommended music search means 107 updates the internet searching keyword so as to correspond to the change request and also causes the operation screen to display the internet searching keyword corresponding to the change request. As a result of the determination, when the recommended music search means 107 has not received a change request for the internet searching keyword, in step S413, a determination is made as to whether the recommended music search means 107 has received an acknowledgement for the present internet searching keyword.

As a result of the determination, when the recommended music search means 107 has received an acknowledgement for the present internet searching keyword, in step S415, the search request means 1073 sends an internet search request using the internet searching keyword to the given WWW server 119. As a result of the determination, when the recommended music search means 107 has not received an acknowledgement for the present internet searching keyword, the process returns to step S409, in which a determination is made again as to whether the recommended music search means 107 has received a change request for the internet searching keyword.

In step S417, the result display means 1075 receives an internet search result corresponding to the internet search request and causes the operation screen to display the internet search result. In step S419, a determination is made as to whether the recommended music search means 107 has received an execution request for the internet search result, whether it has received an acknowledgement for the internet search result, or whether it has received neither of them.

As a result of the determination, when the recommended music search means 107 has received an execution request for the received internet search result, in step S421, the processing means 106 performs an execution process corresponding to the received internet search result. For example, in this execution process, application software, such as “RealAudio Player” or “Windows(™) Media Player”, for replaying a sound-source file is used to play given music. Alternatively, application software, such as “ProTALKER 97 engine”, for text-to-speech processing of a text file is used to perform text-to-speech processing of texts in a text file on a given web page. As a result of the above-described determination, when the recommended music search means 107 has received an acknowledgement for the internet search result, it does nothing and ends the processing. As a result of the above-described determination, when the recommended music search means 107 has received neither an execution request nor an acknowledgement, in step S417, the result display means 1075 receives an internet search result corresponding to the internet search request sent in step S415 and displays the search result on the operation screen.

Reference numeral 805 in FIG. 8 is an example of the operation screen displayed when a search request condition for the internet searching is set. When check boxes corresponding to pre-set internet searching keywords “violin” or “opera” is checked, this indicates that “violin” or “opera” is available as internet searching keywords.

Reference numeral 807 in FIG. 8 indicates an example of the operation screen when an execution for the internet search result is requested. This example shows that a check box corresponding to “Violin Concerto Op. 47/Aki Suwanai/REAL (performance style file)” is checked and a “play button” is pressed.

In the embodiment described above, the description has been given of a case in which the recommended-music search request (request for internet-search) is received from a user. The recommended-music search request (request for internet-search), however, may be automatically given by the recommended music search apparatus when radio listening time becomes over a predetermined interval. Alternatively, the recommended music search apparatus may automatically give the recommended-music search request (request for internet-search) when the apparatus fails to find any receivable radio station or when the apparatus has executed all radio station selection within all receivable radio stations.

Based on the genre of music broadcast on a radio station selected by a user (selected-genre) and information of a given music genre list including the music genre, the apparatus disclosed hereinabove performs processing for obtaining such music and/or associated information as recommended music, of which genre is not same to said selected-genre. Thus, for example, when the user is searching for a radio station broadcasting music that suits his/her mood, the apparatus can easily obtain such music and/or the associated information that suits his/her mood, considering the genre of music broadcast on a radio program previously selected by the user.

1. An apparatus for searching for recommended music in the internet for a listener, the apparatus comprising:
a genre list memorizing means for storing information of a given music genre list;
a selection history memorizing means for storing the frequency of a selected radio station, broadcast music titles and artist names;
an artist's genre memorizing means for storing given music titles and corresponding artist names and its genre names;
a selected-genre extracting means for extracting the corresponding genre names to the given music titles or artist names in said selection history memorizing means, by using said artist's genre memorizing means, wherein said extraction is initiated by receiving a request for internet-search;
a search request means for sending a search request to the predefined WWW server to download the music, with searching keyword of the genre names which are included in said genre list memorizing means, but which are not included in said extracted genre names by said extracting means; and
a result display means for receiving a search result from said WWW server, and displaying it on the apparatus.

2. An apparatus for searching for recommended music in the internet for a listener, the apparatus comprising:
a genre list memorizing means for storing information of a given music genre list;
a selection history memorizing means for storing the frequency of a selected radio station, broadcast music titles and artist names;
an artist's genre memorizing means for storing given music titles and corresponding artist names and its genre names;
a selected-genre extracting means for extracting the corresponding genre names to the given music titles or artist names in said selection history memorizing means, by using said artist's genre memorizing means, wherein said extraction is initiated by receiving a request for internet-search;
a search request means for sending a search request to the predefined WWW server to download the music, with searching keyword of the genre names which are included in said genre list memorizing means, but which are not included in said extracted genre names by said extracting means;
a result display means for receiving a search result from said WWW server, and displaying it on the apparatus; and
a processing means for processing said search result from said WWW server, by using the predefined processes.

3. The apparatus of claim 1, wherein said request for internet-search is automatically sent to said extracting means, when radio listening time becomes over the predetermined interval.

4. The apparatus of claim 1, wherein said request for internet-search is automatically sent to said extracting means, when the apparatus fails to find any receivable radio station.

5. The apparatus of claim 1, wherein said request for internet-search is automatically sent to said extracting means, when the apparatus has executed all radio station selection within all receivable radio stations.

6. The apparatus of claim 1, wherein one or more of the genre names of “classic”, “jazz”, “rock” and “pops” is included in said genre name in said genre list database or in said artist's genre means.

7. The apparatus of claim 2, wherein said predefined process of said processing means is the process to replay a sound-source file.

8. The apparatus of claim 2, wherein said predefined process of said processing means is the text-to-speech reading process.

9. A method for automatically searching for recommended music in the internet for a listener, said method comprising the steps of:
extracting the genre names which correspond to the music titles or artist names in a selection history database in which the frequency of a selected radio station, broadcast music titles and artist names are stored, by using an artist's genre database which stores given music titles and corresponding artist names and its genre names, wherein said extraction is initiated by receiving a request for internet-search;
sending a search request to the predefined WWW server to download the music, with searching keyword of the genre names which are included in a genre list database which stores information of a given music genre list, but which are not included in said extracted genre names by said extracting step; and
receiving a search result from said WWW server, and displaying it on the apparatus.

10. A method for automatically searching for recommended music in the internet for a listener, said method comprising the steps of:
extracting the genre names which correspond to the music titles or artist names in a selection history database in which the frequency of a selected radio station, broadcast music titles and artist names are stored, by using an artist's genre database which stores given music titles and corresponding artist names and its genre names, wherein said extraction is initiated by receiving a request for internet-search;
sending a search request to the predefined WWW server to download the music, with searching keyword of the genre names which are included in a genre list database which stores information of a given music genre list, but which are not included in said extracted genre names by said extracting step;
receiving a search result from said WWW server, and displaying it on the apparatus; and
processing said search result from said WWW server, by using the predefined processes.

11. A computer-readable medium encoded with a plurality of processor-executable instruction sequences for automatically searching for recommended music in the internet for a listener, said instruction sequences comprising:
extracting the genre names which correspond to the music titles or artist names in a selection history database in which the frequency of a selected radio station, broadcast music titles and artist names are stored, by using an artist's genre database which stores given music titles and corresponding artist names and its genre names, wherein said extraction is initiated by receiving a request for internet-search;
sending a search request to the predefined WWW server to download the music, with searching keyword of the genre names which are included in a genre list database which stores information of a given music genre list, but which are not included in said extracted genre names by said extracting step; and
receiving a search result from said WWW server, and displaying it on the apparatus.

12. A computer-readable medium encoded with a plurality of processor-executable instruction sequences for automatically searching for recommended music in the internet for a listener, said instruction sequences comprising:
extracting the genre names which correspond to the music titles or artist names in a selection history database in which the frequency of a selected radio station, broadcast music titles and artist names are stored, by using an artist's genre database which stores given music titles and corresponding artist names and its genre names, wherein said extraction is initiated by receiving a request for internet-search;
sending a search request to the predefined WWW server to download the music, with searching keyword of the genre names which are included in a genre list database which stores information of a given music genre list, but which are not included in said extracted genre names by said extracting step;
receiving a search result from said WWW server, and displaying it on the apparatus; and
processing said search result from said WWW server, by using the predefined processes.
